(19) United States
(12) Patent Application Publication
(10) Pub. No.: US 2019/0218401 A1
(43) Pub. Date: Jul. 18, 2019

(54) CORROSION-RESISTANT COMPOSITION

(71) Applicant: SWIMC LLC, Cleveland, OH (US)

(72) Inventors: Victoria J. GELLING, Medina, MN (US); Tapan DEBROY, Victoria, MN (US); Phyllis A. LUNDEEN, Coon Rapids, MN (US); Brandon J. BROGLY, Coon Rapids, MN (US)

(73) Assignee: The Sherwin-Williams Company

(21) Appl. No.: 16/076,253

(22) PCT Filed: Feb. 10, 2017
(86) PCT No.: PCT/US2017/017383

§ 371 Date: Aug. 7, 2018

Related U.S. Application Data
(60) Provisional application No. 62/293,628, filed on Feb. 10, 2016.
(60) Provisional application No. 62/457,337, filed on Feb. 10, 2017.

(51) Int. Cl. C09D 5/08; C09D 5/44; C08K 3/014; C08K 3/11; C08K 5/098; C08K 3/22; B05D 7/14; B05D 3/00

(52) U.S. Cl. CPC C09D 5/084; C09D 5/086; C09D 5/44; C08K 3/014; C08K 3/11; B05D 2202/10; C08K 3/22; B05D 7/14; B05D 3/002; C08K 2003/2227; C08K 5/098

(57) ABSTRACT

A corrosion-resistant coating composition is provided. The composition includes a binder system comprising at least one polymeric resin and an inorganic bismuth-containing compound. Methods of coating and using the coating composition are also provided.

### CROSS REFERENCE TO RELATED APPLICATION(S)

This International Application claims benefit of U.S. Provisional Application Ser. No. 62/293,628 filed 10 Feb. 2016 and U.S. Provisional Application Ser. No. 62/457,337 filed evendate, each of which is incorporated herein by reference in its entirety.

### BACKGROUND

Corrosion is a serious problem, particularly for metal surfaces exposed to water, rain, snow, conditions of high humidity, or to other highly corrosive environments including acidic environments, high salt environments, and the like. The annual direct cost of metallic corrosion is estimated to be in the billions of dollars.

Several attempts have been made to provide effective corrosion inhibitors. Conventionally, metal surfaces are protected by coating compositions that shield the surface from the environment. However, osmotic pressure tends to build up in a coating, leading to blistering, leaching and even delamination. Once the coating is gone, the metal surface is exposed to corrosion.

The corrosion resistance of a coating can be improved by including a corrosion inhibitor in the composition. Hexavalent chromium is an example of an effective corrosion inhibitor that is widely in use. However, it is also a known carcinogen at low levels, and increasing concerns about health and environment have led to a call to replace hexavalent chromium, and other chromium-based compounds, in coating compositions.

From the foregoing, it will be appreciated that what is needed in the art is an effective corrosion inhibitor that is substantially or even completely free of chromium, and can be used to provide a corrosion-resistant coating composition without environmental or health hazards. Such compositions, and methods for making and using the compositions are disclosed and claimed herein

### SUMMARY

The present description provides corrosion-resistant coating compositions and methods of making and using the same. These compositions may be applied to a wide variety of substrates to provide corrosion protection, and may be used as pretreatment, primer, and/or direct-to-metal coatings, for example.

In an embodiment, the present description provides a coating composition. The composition includes a binder system including at least one polymeric resin, an optional crosslinker, and a corrosion inhibitor including an inorganic bismuth-containing compound.

In another embodiment, the present description provides a corrosion-resistant coated article including a metal substrate and a cured coating disposed on the substrate. The cured coating is derived from a coating composition that includes a binder system including at least one polymeric resin, an optional crosslinker, and a corrosion inhibitor including an inorganic bismuth-containing compound.

In yet another embodiment, the present description provides a method of making a corrosion-resistant coated article. The method includes the steps of providing a metal substrate and applying on the substrate a coating composition includes a binder system including at least one polymeric resin, an optional crosslinker, and a corrosion inhibitor including an inorganic bismuth-containing compound.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### SELECTED DEFINITIONS

Unless otherwise specified, the following terms as used herein have the meanings provided below.

The term “component” refers to any compound that includes a particular feature or structure. Examples of components include compounds, monomers, oligomers, polymers, and organic groups contained there.

The term “substantially free” of a particular component means that the compositions of the present invention contain less than 5 wt % of the component, based on the total weight of the composition. The term “essentially free” of a particular component means that the compositions of the present invention contain less than 1 wt % of the component, based on the total weight of the composition.

The term “polyol” refers to a polymer with two or more hydroxyl (OH) groups.

As used herein, the term may refer to different types of polyols, including, for example, polyether polyols, polyester polyols, and the like.

The term “crosslinker” refers to a molecule capable of forming a covalent linkage between polymers or between two different regions of the same polymer.

The term “self-crosslinking,” when used in the context of a self-crosslinking polymer, refers to the capacity of a polymer to enter into a crosslinking reaction with itself and/or another molecule of the polymer, in the absence of an external crosslinker, to form a covalent linkage therebetween. Typically, this crosslinking reaction occurs through reaction of complimentary reactive functional groups present on the self-crosslinking polymer itself or two separate molecules of the self-crosslinking polymer.

Unless otherwise indicated, a reference to a “(meth)acrylate” compound (where “meth” is bracketed) is meant to include both acrylate and methacrylate compounds.

As used herein, the term “direct-to-metal” (DTM) implies that a coating composition is applied directly to the surface of a metal substrate, where the substrate has not been previously coated with a primer, pretreatment or other coating. As used herein, the term “pretreatment” refers to any organic coating applied to a substrate surface prior to the application of a paint or other protective coating, but does not include standard procedures and/or substances used to clean or prepare the surface, such as, for example, blasting, phosphate-treating, and the like. Therefore, a DTM coating applied without pretreatment may be applied to a clean-blasted surface, a phosphate-treated surface, and the like. DTM coatings combine the adhesion and corrosion resistance of a traditional primer coating with the durability, weatherability and gloss of a topcoat composition. Unless otherwise indicated, a DTM coating does not require prior pretreatment or application of a primer, or the subsequent application of a topcoat.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “chromium-containing compound” as used herein is a reference to chromium compounds including hexavalent chromium, for example, that are currently subject to regulatory restriction or prohibition. “Chromium-free” is intended to mean compositions or components that are substantially or even essentially free of chromium-containing compounds.

The term “thermoplastic” refers to a material that melts and changes shape when sufficiently heated and hardens when sufficiently cooled. Such materials are typically capable of undergoing repeated melting and hardening without exhibiting appreciable chemical change. In contrast, a “thermoset” refers to a material that is crosslinked and does not “melt.”

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

In one aspect, the present description provides a corrosion-resistant coating composition, a coated article, and a method for improving the corrosion resistance of a coated article. The composition includes a binder system and a corrosion inhibitor comprising at least one inorganic bismuth-containing compound. The method includes steps of providing a substrate and applying thereon a corrosion-resistant coating composition.

In an embodiment, the present description provides a corrosion-resistant composition. In a preferred aspect, the composition is a liquid coating or paint, and may be either solvent-borne, water-dispersible, water-reducible or waterborne. The term “liquid coating” as used herein, refers to a composition or system including a dispersion of one or more pigments in a liquid medium or carrier. The liquid medium or carrier may be aqueous or non-aqueous.

The composition described herein includes a binder system including at least one polymeric resin. Suitable resins in the binder may be thermosetting and/or thermoplastic. Conveniently, one or more of these are thermoplastic. Further, some embodiments of a thermoplastic resin useful in the practice of the present invention may be amorphous, crystalline or semicrystalline. Illustrative resins used in the binder system include acyclic, cyclic, branched, linear, aliphatic, or aromatic resins. In an aspect, the binder system described herein may be waterborne, water-reducible, water-dispersible, or solvent-borne.

Suitable polymeric resins include, without limitation, epoxy resin, acrylics, polyolefins, polyurethanes, polyamines, alkyds, polyesters, chlorinated resins, fluorinated resins, and the like. The choice of resin for a coating composition will be determined by the performance requirements of a given end use. In an aspect, the polymeric resin is a urethane, preferably a reaction product of one or more polyols with one or more acids or diols.

Suitable polyols include, without limitation, including, for example, polyether polyols, polyester polyols, and the like. For example, the polyol described herein may be a reaction product of an epoxide or epoxy-functional compound with an acid or a diol. An exemplary polyol of this type is described in U.S. Patent Pub. No. 20160090510 (filed Nov. 30, 2015) and incorporated fully herein by reference.

In an embodiment, the polyol described herein has a theoretical hydroxyl equivalent weight of about 100 to 400, preferably 150 to 350. In an embodiment, the polyol described herein has a hydroxyl number of about 100 to 400, preferably 150 to 350.

Suitable acids include, without limitation, aliphatic and aromatic monocarboxylic and dicarboxylic acids, saturated and/or unsaturated fatty acids, and the like. In an aspect, aliphatic acids used in the preparation of the polyol described herein include monocarboxylic acids, such as, for example, acetic acid, butanoic acid, hexanoic acid, acrylic acid, methacrylic acid, 2-ethyl hexanoic acid, cyanoacrylic acid, crotonic acid, dodecanoic acid, fatty acid dimers, and the like. In another aspect, aliphatic acids used in the preparation of the polyol described herein include dicarboxylic acids such as, for example, succinic acid, glutaric acid, adipic acid, azelaic acid, suberic acid, sebacic acid, decane di-acid, dodecane di-acid, abietic acid, acid dimers, and the like. The aliphatic acids may be straight-chain or branched acids. In yet another aspect, aromatic acids used in the preparation of the polyol described herein include aromatic monocarboxylic acids, such as, without limitation, alkyl substituted aromatic acids, alkenyl substituted aromatic acids, or hydroxy substituted aromatic acids. Examples include benzoic acid, hydroxy benzoic acid, cinnamic acid, and the like. In another aspect, aromatic acids include dicarboxylic acids such as, for example, isophthalic acid, terephthalic acid, phthalic acid, naphthalene dicarboxylic acid, 1,4-cyclohexane dicarboxylic acid (CHDA), oxy dibenzoic acid and the like.

Suitable diols include, without limitation, aliphatic diols selected from unsubstituted or alkyl-substituted aliphatic diols. In an aspect, the diols include, for example, ethylene glycol, diethylene glycol, triethylene glycol, 1,2-propanediol, 1,3-propanediol, 1,2-butanediol, 1,3-butanediol, 1,4-butanediol, pentanediol, hexanediol, trimethylol propane, glycerol, and the like. In an embodiment, an unsubstituted diol, preferably 1,4-butanediol, is used.

In an embodiment, the polyol described herein is the product of a reaction between an epoxide or epoxy-functional compound with an acid or diol. Theirs reaction is carried out in the presence of a reaction catalyst. Suitable catalysts include trialkyl amines, monoalkyl diaryl amines, dialkylaryl amines, triaryl amines, trialkyl phosphines, monoalkyl diaryl phosphines, dialkyl aryl phosphines, trialkyl phosphines, quarternary ammonium compounds, quarternary phosphonium compounds, alkali metal halides, and the like. Quarternary ammonium or phosphonium compounds, and dialkyl aryl amines are preferred. In a preferred embodiment, the reaction catalyst is preferably present in an amount of at least 0.01 wt-%, and more preferably at least 0.1 wt-%, based on the weight of nonvolatile material in the coating composition. The reaction catalyst is preferably present in an amount of no greater than 3 wt-%, and more preferably no greater than 1 wt-%, based on the weight of nonvolatile material in the coating composition.

In an embodiment, the binder system is present in an amount of about 40 to 95, preferably about 55 to 80, and more preferably about 60 to 70 percent by weight, based on the total weight of the composition.

In an aspect, the coating composition described the resin component is self-crosslinking, and in another aspect, the resin component is crosslinkable with an optional crosslinking agent reactive with the functional group(s) of the resin component.

Suitable optional crosslinking agents for use in the compositions and method described herein include, for example, aminoplast resins, polyisocyanates, polyepoxides, polyacids and polyamines, combinations or mixtures thereof, and the like. The choice of particular crosslinker typically depends on the particular product being formulated.

In an embodiment, the optional crosslinking agent is hydroxyl-reactive. In a preferred aspect, the optional crosslinking agent is phenoplasts, aminoplast, isocyanate-functional compounds, dianhydrides, or mixtures thereof.

Suitable phenoplast resins include the condensation products of aldehydes with phenols. Formaldehyde and acetaldehyde are preferred aldehydes. Various phenols can be employed such as phenol, cresol, p-phenylphenol, o-tert-butylphenol, p-test-butylphenol, p-tert-amylphenol, cyclopentylphenol, and the like.

Suitable aminoplast resins are the condensation products of aldehydes such as formaldehyde, acetaldehyde, crotonaldehyde, furfural, benzaldehyde, and the like, with amino- or amido-group-containing substances such as urea, melamine, and benzoguanamine. Examples of suitable aminoplast crosslinking resins include, without limitation, benzoguanamine-formaldellyde resins, melamine-formaldehyde resins, etherified melamine-formaldehyde, and urea-formaldehyde resins.

Suitable isocyanate-functional compounds include, without limitation, blocked or unblocked aliphatic, cycloaliphatic or aromatic di-, tri-, or poly-yalent isocyanates, such as hexamethylene diisocyanate, isophorone diisocyanate and the like. Further non-limiting examples of generally suitable unblocked or blocked isocyanates include isomers of isophorone diisocyanate, dicyclohexylmethane diisocyanate, toluene diisocyanate, diphenylmethane diisocyanate, phenylene diisocyanate, tetramethyl xylene diisocyanate, xylylene diisocyanate, and mixtures thereof. In some embodiments, unblocked or blocked isocyanates are used that have an Mₙ of at least about 300. more preferably at least about 650, and even more preferably at least about 1,000.

Polymeric unblocked or blocked isocyanates are useful in certain embodiments. Some examples of suitable polymeric blocked isocyanates include a biuret or isocyanurate of a diisocyanate, a trifunctional “timer,” or a mixture thereof. Examples of suitable blocked polymeric isocyanates include TRIXENE BI 7951, TRIXENE BI 7984, TRIXENE BI 7963, TRIXENE BI 7981 (TRIXENE materials are available from Baxenden Chemicals, Ltd., Accrington, Lancashire, England), DESMODUR BL 3175A, DESMODUR BL3272, DESMODUR BL3370, DESMODUR BL 3475, DESMODUR BL 4265, DESMODUR PL 340, DESMODUR VP LS 2078, DESMODUR VP LS 2117, and DESMODUR VP LS 2352 (DESMODUR materials are available from Bayer Corp., Pittsburgh, Pa., USA), or combinations thereof.

Suitable dianhydrides include, without limitation, anhydrides of saturated and unsaturated carboxylic acids.

In an embodiment, where the resin component is self-crosslinking, no additional crosslinking agent is required, but one or more crosslinking agents may still be used. In another embodiment, the crosslinking agent is present in an amount from about 10 to 60, preferably 20 to 45, and more preferably 30 to 40 percent by weight, based on the total weight of the composition.

The composition described herein further includes an organotin-free and/or chrome-free corrosion inhibitor, or a corrosion inhibitor that is free of both organotin and chrome. Suitable corrosion inhibitors for use in the compositions and methods described herein preferably include inorganic bismuth-containing compounds, preferably multivalent bismuth salts of various anions, more preferably bismuth salts of metal oxyanions. These compounds include their anhydrous forms, as well as various hydrates, including hemihydrate, pentahydrate and other hydrated forms, along with mixtures and combinations thereof, and the like.

Surprisingly, the coating composition described herein includes an inorganic bismuth-containing compound and demonstrates optimal or even superior corrosion resistance relative to conventional coatings made without corrosion inhibitor(s).

Suitable examples of such bismuth salts of various anions include, without limitation, bismuth silicate, bismuth magnesium aluminosilicate, bismuth aluminate, bismuth borate, bismuth manganate, bismuth hydroxide, bismuth trioxide, bismuth phosphate, and the like. In a preferred aspect, the inorganic bismuth-containing compound is a bismuth salt of a metal oxyanion, such as, for example, bismuth aluminate, bismuth manganate, and mixtures or combinations thereof, and the like. These compounds include their anhydrous forms, as well as various hydrates, including hemihydrate, pentahydrate and other hydrated forms, along with mixtures and combinations thereof, and the like.

In a preferred embodiment, the inorganic bismuth-containing compound is bismuth aluminate, preferably bismuth aluminate hydrate, commercially available from various sources, including Sigma-Aldrich, for example. Bismuth aluminate and bismuth aluminate hydrate may be associated with, or be partially converted to, small amounts of other inorganic bismuth-containing compounds, including bismuth trioxide and bismuth hydroxide, for example.

In some embodiments, the inorganic bismuth-containing compound may be used in combination with one or more organic bismuth-containing compounds. Compounds of this type are described, for example, in U.S. Pat. Nos. 5,554,700; 5,631,214; 5,670,441; 5,859,165; 6,353,057; and 6,190,524.

Examples of optional organic bismuth-containing compounds include bismuth acetate, bismuth subacetate, bismuth carbonate, bismuth salicylate, bismuth subsalicylate, bismuth subcarbonate, bismuth subcitrate, bismuth citrate, bismuth benzoate, bismuth oxalate, bismuth oleate, bismuth dialkyldithiocarbamates, hydroxy acids of bismuth, organosulfur bismuth compounds, reaction products of bismuth with mercaptans and/or hydroxy mercaptans, mixtures or combinations thereof, and the like.

In some embodiments, the inorganic bismuth-containing compounds may be used in combination with other known chrome-free or chromate-free corrosion inhibitors, including a wide range of commercially available powdered pigments and fillers that behave as corrosion inhibitors. Suitable additional and/or optional corrosion inhibitors include, for example, phosphates or polyphophates, molybdates, borates, silicates and phosphites of Zn, Ca, Sr, Ba, Al, Mg, Pb, Cr, Fe, or various combinations of these anionic and cationic species. Other active concision-inhibiting pigments include, for example, organic compounds with SH functionality, such as thiols, derivatives of dithiocarbonic, dithiocarbamic and dithiophosphoric acids, and the like. Such corrosion inhibitors are well known in the art and are described, for example, in U.S. Pat. Nos. 4,612,049 and 3,453,124, among many others.

In an embodiment, the inorganic bismuth-containing compound is present in an amount of about 0.5 to 10, more preferably 0.6 to 5, and most preferably 0.8 to 2 percent by weight, based on the total weight of the composition. If the inorganic bismuth-containing compound is used in conjunction or combination with an organic bismuth-containing compound or other catalyst, the inorganic bismuth-containing composition is present in preferably about a 0.5:1 to 1:1 ratio with the organic bismuth-containing compounds.

In an embodiment, the inorganic bismuth-containing compounds used herein may also function as effective cure catalysts, either used alone or in combination with organic bismuth-containing compounds and/or other catalysts known in the art. The use of inorganic bismuth-containing compounds as catalysts is further described in Applicants' patent applications Docket No. 06-2414-0201 entitled “Novel Electrocoating Composition,” and Docket No. 06-2437-0100, entitled “Novel Powder Coating Composition,” both filed on evendate herewith.

In an embodiment, a coating made from the coating composition and method described herein will demonstrate comparable corrosion resistance, preferably superior corrosion resistance, to conventional coatings made without the inorganic bismuth-containing compositions.

A wide variety of other additional ingredients optionally may be included in the coating composition described herein if desired. Examples of these include one or more defoaming aids, grinding aids, wetting agents, surfactants, coalescing aids, processing aids, skid resistance agents, abrasion resistance agents, conductive agents, antistatic agents, coloring agents, anticorrosion aids, thickeners, sag resistant agents, plasticizers, antioxidants, ultraviolet stabilizers, biocides, fungicides, fillers, combinations of these, and the like. These can be used in accordance with conventional practices currently known or hereafter developed.

In one embodiment, the present description provides a method for making a corrosion-resistant article including the step of providing a metal substrate. Any metal substrate, may be used herein, including ferrous substrates and non-ferrous substrates. Suitable examples of ferrous substrates include, without limitation, stainless steel, weathering steel, cold rolled steel, cold rolled steel with zirconium, hot-dip galvanized steel, electrogalvanized steel, and the like. Non-ferrous substrates include aluminum, zirconium, and the like. Substrates may also include metal alloys, intermetallic compositions, metal-containing composites, combinations of these, and the like.

The substrate may have a pretreatment applied prior to application of the coating composition described herein. Suitable pretreatments include, for example, iron phosphate pretreatment, zinc phosphate pretreatment, zirconium pretreatment, and the like. The pretreatment is typically rinsed with deionized water, and/or optionally sealed with a chromate sealer, a non-chrome sealer, or a phosphate sealer, and the like.

The coating composition described herein may be applied by any means known in the art. Suitable methods for application include, for example, brush coating, spray coating, dip coating, spin coating, roll-to-roll coating, coil coating, electrocoating, and the like.

The composition described herein can be used with a variety of substrates to provide corrosion-resistant coating. Exemplary substrates include, without limitation, natural and engineered buildings and building materials, freight containers, flooring materials, walls, furniture, household appliances, other building materials (including rebar used to reinforce concrete, structural steel, motor vehicle components, aircraft components, trucks, rail cars and engines, bridges, water towers, cell phone tower, wind towers, radio towers, lighting fixtures, statues, billboard supports, fences, guard rails, tunnels, pipes, marine components, machinery components, laminates, equipment components, appliances, packaging, and the like.

In a preferred aspect, the coating made using the methods described herein demonstrates optimal corrosion resistance. Coated test panels are scribed to metal and exposed to salt fog according to the method of ASTM D1654-08, as further described below. Suitable coatings will demonstrate minimal paint loss or creep from scribe of preferably less than about 4 mm, more preferably less than about 3 mm, even more preferably less than 2 mm, and most preferably less than 1 mm. Commercially viable coatings have creep from scribe of less than 3 mm.

The resulting coated article desirably includes a coating that provides excellent corrosion protection and optimal smoothness, while also being an environmentally friendly tin-free and chrome-free system.

### EXAMPLES

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Mo.

### TEST METHODS

Unless indicated otherwise, the following test methods were utilized in the Examples that follow.

### Corrosion Potential Measurement

The corrosion resistance of a coated metal substrate can be tested indirectly by a measurement of corrosion potential of the metal substrate. For the test, the metal substrate is exposed to an electrolyte solution either in the presence or absence of a corrosion inhibitor for a given period of time after which the corrosion potential of the substrate is measured. A shift in the potential in a positive direction represents a corrosion-resistant substrate, where a large negative potential is indicative of significant corrosion.

### Corrosion Resistance (Salt Fog)

The corrosion resistance of cured coatings prepared from the composition described herein is tested using the salt fog method, as described in ASTM B117 (Standard Practice for Operating Salt Fog Apparatus). Results are expressed on a scale of 0-10, where “0” indicates the coating is completely corroded, observed by bubbling or blistering of the film in all areas, and “10” indicates the coating is unchanged from before it was subjected to the corrosive environment. Rust ratings for coatings subjected to salt fog exposure in a humid environment are also expressed on a scale of 0-10 where “0” indicates complete surface rust, and “10” indicates no surface rust, as indicated in ASTM D714-02 (Standard Test Method for Evaluating Degree of Blistering of Paints).

### Corrosion Resistance (Creep)

The corrosion resistance of cured coatings prepared from the composition described. herein is also tested by measuring creep after exposure to a corrosive enviromnent, as described in ASTM D1654-08 (Standard Test Method for Evaluation of Painted or Coated Specimens Subjected to Corrosive Environments). A coating is applied to a panel and cured. The panel is then scribed to metal and exposed to salt fog for a given period of time. Paint loss from the scribe is measured, and results are expressed as the amount of creep (in mm) from the scribe. For commercially viable coatings, creep from scribe of 3 mm or less is desired.

### Example 1. Corrosion Potential

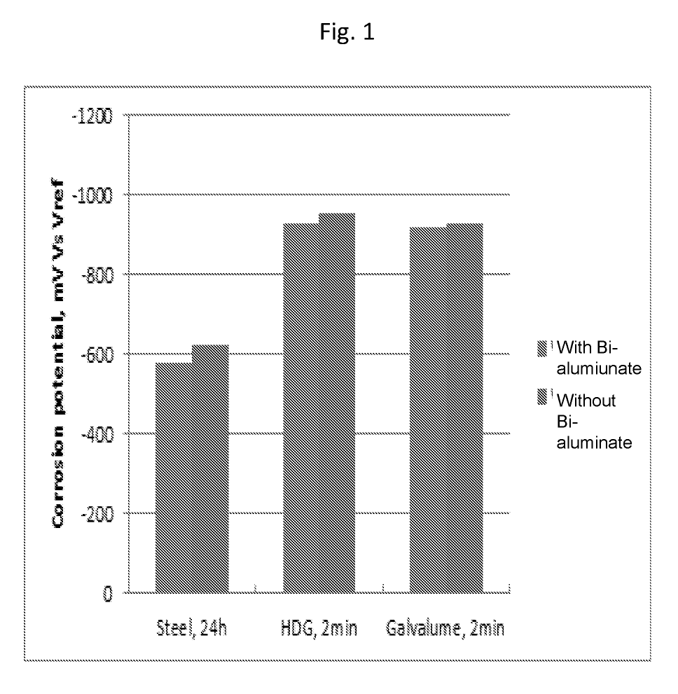

To determine the corrosion resistant effect of the compositions described herein, various uncoated metal substrates were exposed to 150 mL of a 5% solution of NaCl (acidified to a pH of 4) with or without 0.25 g of bismuth aluminate hydrate for the time indicated in Table 1. Corrosion potential was measured for each sample. Results are shown in FIG. 1.

TABLE 1
Corrosion Potential

| Substrate | Time | |
|---|---|---|
| Steel (control) | 24 | h |
| Steel (with bismuth aluminate) | | |
| Hot-dip galvanized (control) | 2 | min |
| Hot-dip galvanized (with bismuth | | |
| aluminate) | | |
| GALVALUME (control) | 2 | min |
| GALVALUME (with bismuth aluminate) | | |

### Example 2. Corrosion Resistance

To determine the effectiveness of the corrosion inhibitors described herein, two sets of B1000 cold-rolled steel test panels (with either only a deionized water rinse applied (B1000/DIW) or with a phosphate pretreatment applied (B1000/P60)) were coated with a polyurethane coating composition including a specified amount of bismuth citrate or a 1:1 mixture of bismuth citrate and aluminate. Samples were coated as shown in Table 2 below. Each panel is then subjected to salt fog exposure and corrosion resistance is reported in terms of blister formation on the coated surface or as creep from scribe (in mm). Results are shown in Table 2.

TABLE 2
Corrosion Resistance Testing

| | | | | | Creep | Maximum | |
|---|---|---|---|---|---|---|---|
| | | | Film | | From | Creep from | |
| | | | Thickness | | Scribe | Scribe | Blister |
| Substrate | Additive | Coating | (mils) | Hours | (mm) | (mm) | Rating |
| B1000/DIW | Control | | 1.8 | 336 | 8.8 | 13.3 | 10 |
| | | | 1.8 | | 8.4 | 11.2 | Few #8 |
| | | | 2.2 | | 8.1 | 11.7 | Few #8 |
| | RMX-Bismuth Citrate | 0.39% | 2.1 | | 8.5 | 12.2 | Few #8 |
| | | | 2.1 | | 7.7 | 12.6 | Few #8 |
| | | | 2.0 | | 8.1 | 15.8 | Few #8 |
| | RMX-Bismuth Citrate | 1.16% | 2.1 | | 9.7 | 15.7 | Few #8 |
| | | | 1.9 | | 14.7 | 28.7 | Few #8 |
| | | | 1.8 | | 9.1 | 12.5 | Few #8 |
| | RMX-Bismuth Citrate/ | 0.2%/0.2% | 2.0 | | 12.0 | 31.1 | Few #8 |
| | RMX-Bismuth Aluminate | | 1.9 | | 8.4 | 10.1 | Few #8 |
| | | | 2.0 | | 8.7 | 13.8 | Few #8 |
| | RMX-Bismuth Citrate/ | 0.58%/0.58% | 2.2 | | 6.9 | 11.8 | Few #8 |
| | RMX-Bismuth Aluminate | | 2.3 | | 9.3 | 13.2 | Few #8 |
| | | | 1.9 | | 8.3 | 11.7 | Few #8 |
| B1000/P60 | Control | | 2.5 | 700 | 0.6 | 3.4 | 10 |
| | | | 2.3 | | 1.3 | 3.6 | 10 |
| | | | 2.5 | | 0.7 | 3.4 | 10 |
| | RMX-Bismuth Citrate | 0.39% | 1.9 | | 0.3 | 2.0 | 10 |
| | | | 2.1 | | 0.6 | 2.5 | 10 |
| | | | 1.9 | | 0.9 | 2.9 | Few #8 |
| | RMX-Bismuth Citrate | 1.16% | 2.0 | | 0.5 | 2.9 | 10 |
| | | | 1.7 | | 1.0 | 2.7 | 10 |
| | | | 2.2 | | 0.6 | 2.7 | 10 |
| | RMX-Bismuth Citrate/ | 0.2%/0.2% | 2.1 | | 0.6 | 2.9 | 10 |
| | RMX-Bismuth Aluminate | | 2.4 | | 1.1 | 2.8 | Few #8 |
| | | | 2.1 | | 1.1 | 4.1 | Few #8 |
| | RMX-Bismuth Citrate/ | 0.58%/0.58% | 2.4 | | 0.6 | 2.6 | 10 |
| | RMX-Bismuth Aluminate | | 1.7 | | 0.5 | 1.8 | 10 |
| | | | 2.0 | | 1.0 | 2.2 | Few #6 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

What is claimed is:

1. (canceled)

2. A corrosion-resistant coated article, comprising:
a metal substrate; and
a cured coating disposed on the metal substrate, wherein the cured coating is derived from a coating composition comprising:
a binder system comprising
at least one polymeric resin;
optionally, a crosslinker; and
a corrosion inhibitor comprising an inorganic bismuth-containing compound.

3. A method of making a corrosion-resistant coated article, comprising:
providing a metal substrate;
applying on the metal substrate a coating composition according to claim 2;
a corrosion inhibitor comprising an inorganic bismuth-containing compound.

4. The article of claim 2, wherein the inorganic bismuth-containing compound is selected from bismuth silicate, bismuth magnesium aluminosilicate, bismuth aluminate, bismuth aluminate, bismuth borate, bismuth manganate, bismuth hydroxide, bismuth trioxide, bismuth phosphate, and mixtures or combinations thereof.

5. The article of claim 2, wherein the bismuth-containing compound is bismuth aluminate.

6. The article of claim 2, wherein the corrosion inhibitor is a combination of an inorganic bismuth-containing compound and an organic bismuth-containing compound.

7. The article of claim 2, wherein the bismuth-containing compound is an organic bismuth-containing compound selected from bismuth acetate, bismuth subacetate, bismuth carbonate, bismuth salicylate, bismuth subsalicylate, bismuth subcarbonate, bismuth subcitrate, bismuth citrate, bismuth benzoate, bismuth oxalate, bismuth oleate, bismuth dialkyldithiocarbamates, hydroxy acids of bismuth, organosulfur bismuth compounds, reaction products of bismuth with mercaptans and/or hydroxy mercaptans, mixtures or combinations thereof.

8. The article of claim 2, wherein the organic bismuth-containing compound is bismuth citrate.

9. The article of claim 2, wherein the corrosion inhibitor is a 1:1 combination of bismuth aluminate and bismuth citrate.

10. The article of claim 2, wherein the cured coating is derived from a coating composition is applied to the substrate by an electrodeposition process.

11. The article of claim 2, wherein the cured coating is a direct-to-metal coating.

12. The article of claim 2, wherein the substrate is a ferrous metal substrate.

13. The article of claim 2, wherein the substrate is a non-ferrous metal substrate.

14. The article of claim 2, wherein the substrate has a pretreatment applied thereon prior to the application of the coating composition.
